(19) United States
(12) Patent Application Publication
(10) Pub. No.: US 2020/0242613 A1
(43) Pub. Date: Jul. 30, 2020

(54) REAL-TIME RESOURCE TRANSFER AND COMMUNICATION EXCHANGE SYSTEM

(71) Applicant: BANK OF AMERICA CORPORATION, Charlotte, NC (US)

(72) Inventor: Rosemary Carbery Stack, Wilmington, DE (US)

(73) Assignee: BANK OF AMERICA CORPORATION, Charlotte, NC (US)

(21) Appl. No.: 16/262,656

(22) Filed: Jan. 30, 2019

(51) Int. Cl. G06Q 20/40; G06Q 20/02

(52) U.S. Cl. CPC G06Q 20/4016; G06Q 20/023

(57) ABSTRACT

A resource transfer system that is utilized to allow the entities to enter into interactions using real-time resource transfers, identify potential misappropriators before entering into interactions, and/or provide an interaction communication exchange that allows entities to communicate regarding the interactions to adjust the real-time resource transfers.

### FIELD

The present invention relates to a resource transfer system, and more particularly to a resource transfer system that includes a communication exchange that allows the entities involved in an interaction to make decisions regarding the resource transfers without involving the organizations facilitating the resource transfer.

### BACKGROUND

Resource processing for interactions typically requires a chain of various systems and entities in order to provide entry points for authorization, collection of resources, movement of resources along processing rails, gateways for network communications, or the like, which all require large amounts of processing capacity and memory storage in order to allow for such resource processing, and potential return processing.

### SUMMARY

The following presents a simplified summary of one or more embodiments of the present invention, in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments of the present invention in a simplified form as a prelude to the more detailed description that is presented later.

It should be understood that during typical interactions, such as automated clearing house (ACH) interactions, via card network, or the like, the interactions and all processing and communication related to such interactions occurs through the organization facilitating the interactions (e.g., the one or more organizations through which the resources are being transferred). As such, in some embodiments after an interaction is entered into a resource transfer system will send the resource organization a file at the end of the day for a plurality of interactions that are used for reconciliation. It should be understood that the entities entering the interaction have little control over how the resources associated with the interaction are processed, as well as little control over any communications between the entities when needed (e.g., should a resource change, rescission, refund, or the like be needed).

As will be described herein in further detail the present invention provides a resource transfer system that may rout resources using a real-time payment network. Using real-time network clearing, the system may provide real-time reconciliation processing along a real-time payment network. In this way, the system may eliminates and/or reduce potential liabilities of misappropriation, as will be discussed herein. The system may confirm a transaction, confirm that resources have been exchanged, and provide end-of-minute confirmation that both sides of an interaction are whole and reconciliation has been completed.

Currently, the confirmation of reconciliation across various entities comes in the form of an end-of-day data packet from a payment network or rail not real-time (e.g., end-of-minute, near instantaneously, or instantaneously, or the like) as presented in the present invention. For example, an entity (e.g., individual, other party, or the like) may transfer resources across financial institutions to another entity. In this way, the individual's financial institution may remove resources from a resource pool (e.g., account) associated with a first entity at the financial institution and move it to a federal account. A payment network moves resources into another resource pool at another financial institution associated with the second entity. However, the other financial institution houses the resources until the end of the day reconciliation. Until then, the second entity does not have the resource in the resource pool.

In some embodiments, the invention provides a real-time resource transfer reconciliation process. Using real-time network clearing, the system may provide real-time reconciliation processing along a real-time payment network. As such, in real-time the resources are transferred out of a first entity's resource pool across the real-time payment network into the second entity's resource pool without lag from network processing. The system tracks the resources across the network and confirms a transaction, confirming that resources have been exchanged. Thereby providing a real-time confirmation that both parties are whole and reconciliation has been completed.

The resource transfer systems of the present disclosure may be utilized to allow the entities to enter into interactions using real-time resource transfers, identity potential misappropriators before entering into interactions, and/or provide an interaction communication exchange that allows entities to communicate regarding the interactions to adjust the real-time resource transfers.

Embodiments of the invention comprise a system, a computer implemented method, and/or a computer program product for a resource transfer and communication exchange system. The embodiments of the present disclosure comprise receiving a request from a first entity to enter into an interaction with a second entity, wherein the interaction includes a transfer of resources from the first entity to the second entity. Thereafter, verification of the first entity or the second entity for the interaction is performed. The resources are secured from the first entity for the interaction. A communication request is received from the first entity or the second entity for communication between the first entity and the second entity regarding the interaction. The communication between the first entity and the second entity is allowed. An agreement is received from the first entity or the second entity for an interaction adjustment. The interaction is adjusted based on the agreement from the first entity and the second entity.

In further accord with embodiments of the invention, an interaction identifier is assigned to the interaction.

In other embodiments the invention further comprises identifying interaction information for the interaction between the first entity and the second entity, and including the interaction information in the communication between the first entity and the second entity.

In still other embodiments of the invention, the interaction information is identified by the interaction identifier assigned to the interaction between the first entity and the second entity.

In yet other embodiments of the invention, the interaction information comprises a status of the interaction, the resources being transferred, a product associated with the interaction, a resource transfer schedule, a first entity resource pool, and a second entity resource pool.

In other embodiments of the invention, the communication comprises real-time messages between the first entity and the second entity through one or more resource transfer systems without input from an organization facilitating the interaction.

In further accord with embodiments of the invention, adjusting the interaction based on the agreement occurs by accessing the interaction based on an interaction identifier.

In other embodiments of the invention, the agreement between the first entity and the second entity occurs through the communication between the first entity and the second entity without involvement from an organization.

In still other embodiments of the invention, the agreement is a return of the resources to the first entity.

In yet other embodiments of the invention, the agreement is an adjustment of the resources for the interaction and a return of a portion of the resources to the first entity or an increase in the resources provided to the second entity.

In other embodiments of the invention, the resource transfer from the first entity to the second entity is in response to the interaction for a product from the second entity.

In further accord with embodiments of the invention, the resource transfer from the first entity to the second entity is in response to sharing resources for a product from a third-party.

In other embodiments of the invention, verifying the interaction comprises identifying when the second entity is using a new resource pool for the interaction, when a resource amount is greater than a threshold amount, or when a second entity resource pool has not been used within a time period, and notifying the first entity of a potential safety indication.

In still other embodiments of the invention, before securing the resources from the first entity for the interaction a safety indication for the interaction is determined, and the first entity is notified of the safety indication before allowing the first entity to enter into the interaction.

In yet other embodiments of the invention, before securing the resources from the first entity for the interaction a potential safety indication is determined for the interaction, the first entity safety preferences are accessed, and the first entity is notified of the safety indication when the safety preferences are met, while the interaction is allowed when the safety preferences are not met.

In other embodiments of the invention, verifying the interaction comprises identifying when the second entity is a pre-verified entity, notifying the first entity when the second entity is not the pre-verified entity, and allowing the interaction when the second entity is the pre-verified entity.

In further accord with embodiments of the invention, verifying the interaction comprises identifying a trustworthiness identifier for the second entity, and notifying the first entity of the trustworthiness identifier for the second entity before allowing the interaction.

To the accomplishment the foregoing and the related ends, the one or more embodiments comprise the features hereinafter described and particularly pointed out in the claims. The following description and the annexed drawings set forth certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference will now be made to the accompanying drawings, and wherein:

FIG. 1 illustrates a block diagram of a resource transfer system environment, in accordance with embodiments of the invention.

FIG. 2 illustrates a process for transferring resources and allowing entity communication, in accordance with embodiments of the invention.

### DETAILED DESCRIPTION OF EMBODIMENTS OF THE INVENTION

Embodiments of the invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. In the following description, for purposes of explanation, numerous specific details are set forth in order to provide a thorough understanding of one or more embodiments. It may be evident, however, that such embodiment(s) may be practiced without these specific details. Like numbers refer to like elements throughout.

Embodiments of the present disclosure relate to a resource transfer system that is utilized to allow the entities to enter into interactions using real-time resource transfers, identify potential misappropriators before entering into interactions, and/or provide an interaction communication exchange that allows entities to communicate regarding the interactions to adjust the real-time resource transfers. The embodiments of the present disclosure, as will be illustrated by the discussion of the embodiments herein, provides improved security for real-time resource transfers associated with interactions because the entities have tool for identifying if the opposing entity is a potential misappropriator. Furthermore, the embodiments of the present disclosure reduce the computer processing capacity requirements, increase processing speeds associated with interactions, and reduce the memory storage requirements of real-time resource processing because the message exchange system allows for direct communication between the interacting entities without the organization having to be involved as an intermediary for each of the communications between the entities. Moreover, the organization does not have to perform its own investigation into the legitimacy of a resource transfer because the entities are able to communicate directly with each other to discuss the interaction. Furthermore, the benefits of the increased processing capacity, increased processing speeds, and/or reduced memory requirements are achieve by allowing the entities to come to an agreement over the communication exchange regarding the interaction (e.g., transfer of resources), authorize the interaction over the communication exchange and allow the organization to make an adjustment to the interaction (e.g., through the use of an interaction identifier assigned to the original interaction and/or the agreed adjustment—or modifications of the interaction identifier that allow tracking of related interactions and/or adjustments) without having to create a separate entirely new interaction.

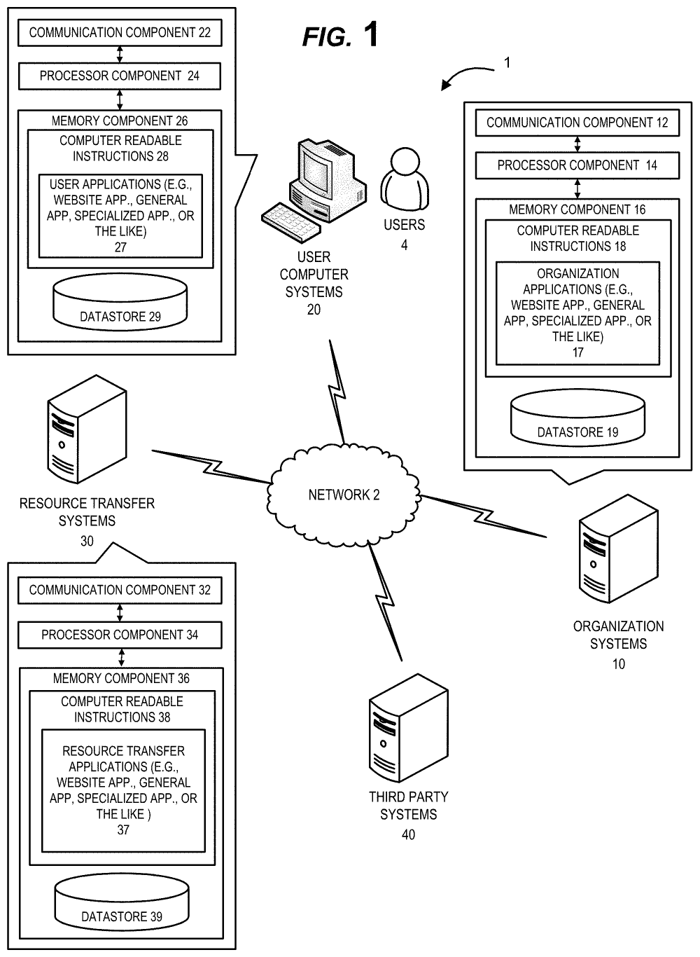

FIG. 1 illustrates a resource transfer system environment 1, in accordance with embodiments of the invention. As illustrated in FIG. 1, one or more organization systems 10 are operatively coupled, via a network 2, to one or more user computer systems 20, one or more resource transfer systems 30 (e.g., a real-time resource transfer), one or more third party systems 40, and/or one or more other systems (not illustrated).

In this way, the one or more organization systems 10 may be the systems that run the applications that the organization uses within the organization's operations (e.g., that store and process interactions using resources from resource pools of entities). The users 4 (e.g., one or more associates, employees, agents, contractors, sub-contractors, third-party representatives, customers, or the like), may include customers, representatives of third-parties (e.g., merchants, third-parties intermediaries, or the like), employees of the organization, or the like. The users 4 may use the user computer systems 20 to enter into interactions with each other directly and/or through third parties systems 40 (e.g., customer user entering into an interaction with an employee user and/or the third party through the third party systems 40, first user entering into an interaction with a second user—such as user splitting resources, transferring resources with respect to a product, or the like). The resource transfer systems 30 may be utilized to allow the users 4 to enter into interactions, provide an interaction communication exchange that allows users to communicate regarding the interactions, provide routing and receiving options for the entities, and route the resources in response to entity selections, or the like. The third party systems 40, as discussed above may provide products (e.g., goods and/or services) associated with an interaction. The other systems (not illustrated) may act as an intermediary between the various systems described herein. The users 4 and/or third-parties may each be described as entities, such that a first entity may enter into interactions and/or communicate with a second entity using the resource transfer systems 30, which may be provided by an organization and/or another third-party, as will be described herein.

The network 2 illustrated in FIG. 1 may be a global area network (GAN), such as the Internet, a wide area network (WAN), a local area network (LAN), or any other type of network or combination of networks. The network 2 may provide for wireline, wireless, or a combination of wireline and wireless communication between systems, services, components, and/or devices on the network 2.

As illustrated in FIG. 1, the one or more organization systems 10 generally comprise one or more communication components 12, one or more processor components 14, and one or more memory components 16. The one or more processor components 14 are operatively coupled to the one or more communication components 12 and the one or more memory components 16. As used herein, the term “processor” generally includes circuitry used for implementing the communication and/or logic functions of a particular system. For example, a processor component 14 may include a digital signal processor, a microprocessor, and various analog-to-digital converters, digital-to-analog converters, and other support circuits and/or combinations of the foregoing. Control and signal processing functions of the system are allocated between these processor components according to their respective capabilities. The one or more processor components 14 may include functionality to operate one or more software programs based on computer-readable instructions 18 thereof, which may be stored in the one or more memory components 16.

The one or more processor components 14 use the one or more communication components 12 to communicate with the network 2 and other components on the network 2, such as, but not limited to, the one or more user computer systems 20, the one or more resource transfer systems 30 (e.g., resource transfer communication exchange system, resource transfer routing system, or the like), the one or more third party systems 40, and/or other systems (not illustrated). As such, the one or more communication components 12 generally comprise a wireless transceiver, modem, server, electrical connection, electrical circuit, or other component for communicating with other components on the network 2. The one or more communication components 12 may further include an interface that accepts one or more network interface cards, ports for connection of network components, Universal Serial Bus (USB) connectors and the like.

As further illustrated in FIG. 1, the one or more organization systems 10 comprise computer-readable instructions 18 stored in the one or more memory components 16, which in one embodiment includes the computer-readable instructions 18 of organization applications 17 (e.g., web-based applications, dedicated applications, specialized applications, or the like that are used to operate the organization, which may be internal and/or external applications). In some embodiments, the one or more memory components 16 include one or more data stores 19 for storing data related to the one or more organization systems 10, including, but not limited to, data created, accessed, and/or used by the one or more organization applications 17. The one or more organization applications 17 may be applications that are specifically used for operating the organization (e.g., the external and/or internal operation of the organization), such as by communicating (e.g., interacting with, or the like) the one or more user computer systems 20 and user applications 27, the one or more resource transfer systems 30 and resource transaction applications 37, the third party systems 40 (and applications thereof), and/or other systems and applications thereof (not illustrated). It should be understood that the one or more organization applications 17 may comprise the applications that are used by the organization to control, monitor, deliver, transfer, or the like, the resources of its customers (e.g., users and/or third party systems, such as product provider systems, or the like).

As further illustrated in FIG. 1, the one or more user computer systems 20 are operatively coupled, via a network 2, to the one or more organization systems 10, the one or more resource transfer systems 30, the one or more third party systems 40, and/or the one or more other systems (not illustrated). As illustrated in FIG. 1, users 4 may use the resource transfer systems 30 to enter into interactions with other entities (e.g., other users, third parties, or the like) in which resources are transferred, and moreover, communicate with the other entities without having to the involve the organization and/or transfer the resources based on routing and receiving options, as will be discussed in further detail herein.

It should be understood that the one or more user computer systems 20 may be any type of device, such as a desktop, mobile device (e.g., laptop, smartphone device, PDA, tablet, watch, wearable device, interaction terminal, or other mobile device), interaction terminal, server, and/or any other type of system hardware that generally comprises one or more communication components 22, one or more processor components 24, one or more memory components 26, and/or the one or more user applications 27, such as web browser applications, dedicated applications, specialized applications, or portions thereof. The one or more processor components 24 are operatively coupled to the one or more communication components 22, and the one or more memory components 26. The one or more processor components 24 use the one or more communication components 22 to communicate with the network 2 and other components on the network 2, such as, but not limited to, the one or more organization systems 10, other user computer systems 20, the one or more resource transfer systems 30, the one or more third party systems 40, and/or other systems (not illustrated). As such, the one or more communication components 22 generally comprise a wireless transceiver, modem, server, electrical connection, or other component for communicating with other components on the network 2. The one or more communication components 22 may further include an interface that accepts one or more network interface cards, ports for connection of network components, Universal Serial Bus (USB) connectors and/or the like. Moreover, the one or more communication components 22 may include a keypad, keyboard, touch-screen, touchpad, microphone, speaker, mouse, joystick, other pointer, button, soft key, and/or other input/output(s) for communicating with the users 4.

As illustrated in FIG. 1, the one or more user computer systems 20 may have computer-readable instructions 28 stored in the one or more memory components 26, which in one embodiment includes the computer-readable instructions 28 for user applications 27, such as dedicated applications (e.g., apps, applet, or the like), portions of dedicated applications, a web browser or other applications that allow the one or more user computer systems 20 to perform the actions described herein (e.g., enter interactions, transfer resources, communicate directly with the opposing entity, or the like).

As illustrated in FIG. 1, the one or more resource transfer systems 30 are operatively coupled, via a network 2, to the one or more organization systems 10, the one or more user computer systems 20, the one or more third party systems 30, and/or the other systems. The resource transfer systems 30, as will be described in further detail herein, may be utilized to facilitate interactions with resource transfers, interaction communications directly between the entities without the need for the organization that facilitated the resource transfer, processing of the resources based on routing selections and/or receiving selections of the entities, or the like. As such, the interactions made through the resource transfer systems 30 allow for resource transfers between entities (e.g., users 4, third parties, or the like), as well as communications between the entities directly with each other (instead of through traditional networks) and/or routing of resources that are more efficient, and thus, more cost effective, as will be discussed herein. It should be understood that the one or more resource transfer systems 30 may be a part of, and thus controlled by the organization, a third party, and/or by other systems (not illustrated). As such, the one or more resource transfer systems 30 may be supported by a third-party and/or by the organization.

The resource transfer systems 30 generally comprise one or more communication components 32, one or more processor components 34, and one or more memory components 36. The one or more processor components 34 are operatively coupled to the one or more communication components 32, and the one or more memory components 36. The one or more processor components 34 use the one or more communication components 32 to communicate with the network 2 and other components on the network 2, such as, but not limited to, the one or more organization systems 10, the one or more user computer systems 20, the one or more third party systems 40, and/or the other systems. As such, the one or more communication components 32 generally comprise a wireless transceiver, modem, server, electrical connection, or other component for communicating with other components on the network 2. The one or more communication components 32 may further include an interface that accepts one or more network interface cards, ports for connection of network components, Universal Serial Bus (USB) connectors and the like.

As illustrated in FIG. 1, the one or more resource transfer systems 30 may have computer-readable instructions 38 stored in the one or more memory components 36, which in some embodiments includes the computer-readable instructions 38 of one or more resource transfer applications 37 that allow the entities (e.g., users 4, third party product providers, or the like) to enter into interactions using the user computer systems 20 through the one or more organization systems 10 (or the one or more third party systems 40), to communicate with each other directly regarding the interactions, and/or to provided routing selections and/or receiving selections for the resources, as will be described herein.

Moreover, the one or more third party systems 40 and/or other systems may be operatively coupled to and communicate with the one or more organization systems 10, the one or more user computer systems 20, and/or the one or more resource transfer system 30, through the network 2. The one or more third party systems 40 and/or the one or more other systems may have the same or similar components as the one or more organization systems 10, the one or more user computer systems 20, and/or the one or more resource transfer systems 30 (e.g., communication component, processor component, memory component—computer readable instructions for applications, datastore), and/or each other in the same or similar way as previously described with respect to the one or more organization systems 10, the one or more user computer systems 20, and/or the one or more resource transfer systems 30.

The one or more third party systems 40 may comprise the systems that a third party (e.g., a product provider) uses to enter into interactions with user 4. For example, the third-party may be a merchant that provides a product (e.g., goods or services) to users during an interaction, and collects resources through the one or more organization systems 10. It should be understood that both the user 4 and the product provider may have resource pools (e.g., accounts, or the like) with one or more organizations in order to allow for a resource transfer associated with the interaction.

A resource pool (e.g., an account) is the relationship that an entity (e.g., user or third-party—such as a merchant) has with an organization, such as a financial institution. Examples of resource pools include a deposit resource pool, such as an interaction account (e.g., a banking account), a savings resource pool, an investment resource pool, a money market resource pool, a time deposit resource pool, a demand deposit resource pool, a pre-paid resource pool, credit resource pool, a non-monetary entity profile that includes information associated with the entity, or the like. The resource pool is associated with and/or maintained by the organization. Moreover, it should be understood that resources may include funds in the resource pools of the entity and/or other property owned by the entity. The resources may be associated with resource pools or may be property that is not associated with a specific resource pool. Examples of resources associated with resource pools may be accounts that have cash or cash equivalents, or resource pools that are funded with or contain property, such as safety despots that contain jewelry, a trust resource pool that is funded with property, or the like. Examples of resources that may not be associated with resource pools may be products, such as antiques in a user's home, jewelry in a user's home, or the like.

A resource transfer refers to any movement of resources, including a change in ownership of the resources between a first entity (e.g., first user or first merchant) and a second entity (e.g., second user or second merchant) directly and/or through an organization. For example, a resource transfer may relate to an interaction (e.g., transaction, transfer, or the like), such as a purchase of a product (e.g., goods or services), a return of a product, a payment interaction, a credit interaction, lines of credit interaction, automated teller machine (ATM) interaction, or other interaction involving an entity's resource pool. An interaction may include one or more of the following: renting, selling, and/or leasing product(s) (e.g., cars, apartments, furniture, tools, or the like); making payments to creditors (e.g., paying monthly bills, paying federal, state, and/or local taxes; and the like); sending remittances; loading money onto stored value cards (SVCs) and/or prepaid cards; donating to charities; splitting payments for products (e.g., splitting hotel, dinner, lunch, transportation, or like costs), and/or the like.

An interaction involving a resource transfer may also refer to a resource transfer between entities (e.g., users, merchants, processor or settlement entities, and/or other entities) participating in and leveraging a settlement network operating in real-time (e.g., real or near real-time for twenty-four hours a day, seven days a week), wherein settlement of the interaction occurs at or very close in time to the time to the interaction. A real-time interaction may include a payment, wherein a real-time interaction system enables participants to initiate credit transfers, receive settlement for credit transfers, and make available to a receiving participant funds associated with the credit transfers in real-time, wherein the credit transfer may be final and irrevocable. Real-time interactions or payments provide marked improvements over conventional interaction clearing and payment settlement methods (e.g., automated clearing house (ACH), wire, or the like) which can require several hours, days, or longer to receive, process, authenticate a payment, and make funds available to the receiving participant which may, in total, require several back-and-forth communications between organization facilitating the resource transfer (e.g., financial institutions). In some cases, conventional settlement methods may not be executed until the end of the business day (EOB), wherein payments are settled in batches between financial institutions.

Real-time interactions reduce settlement time by providing pre-authentication or authentication at the time of a requested interaction in order to enable instantaneous (e.g., immediate or near-instantaneous) settlement between financial institutions at the time of the interaction, wherein resources or funds may be made immediately available to a receiving participant (e.g., payee) following completion of the interaction. Examples of real-time interactions include business to business interactions (e.g., supplier payments), business to consumer interactions (e.g., legal settlements, insurance claims, employee wages), consumer to business interactions (e.g., bill pay, hospital co-pay, payment at point-of-sale), and peer to peer (P2P) interactions (e.g., repayment or remittance between friends and family or others). In a specific example, a real-time interaction may be used for payment of a utility bill on the due date of the bill to ensure payment is received on-time and accruement of additional fees due to late payment is avoided. In another example, real-time interactions may be especially beneficial for small entities and users (e.g., small merchants/businesses) that may have a heavier reliance on short-term funds and may not prefer to wait days for transaction settlements.

Real-time interactions not only provide settlement immediacy, but also provide assurance, fraud reduction, and bank-grade security to payments due to the inherent nature of the payment and user authentication infrastructure. Further, real-time interactions reduce processing requirements, processing memory, and/or processing costs due to the simplified nature of required communication when compared to conventional settlement methods. In some embodiments, real-time interaction systems further include information and conversation tools provided by the organization that enhance the experience of the entities participating in the in the interactions. It should be understood that in some embodiments the interaction requests for the resource transfers may comply with ISO 20022.

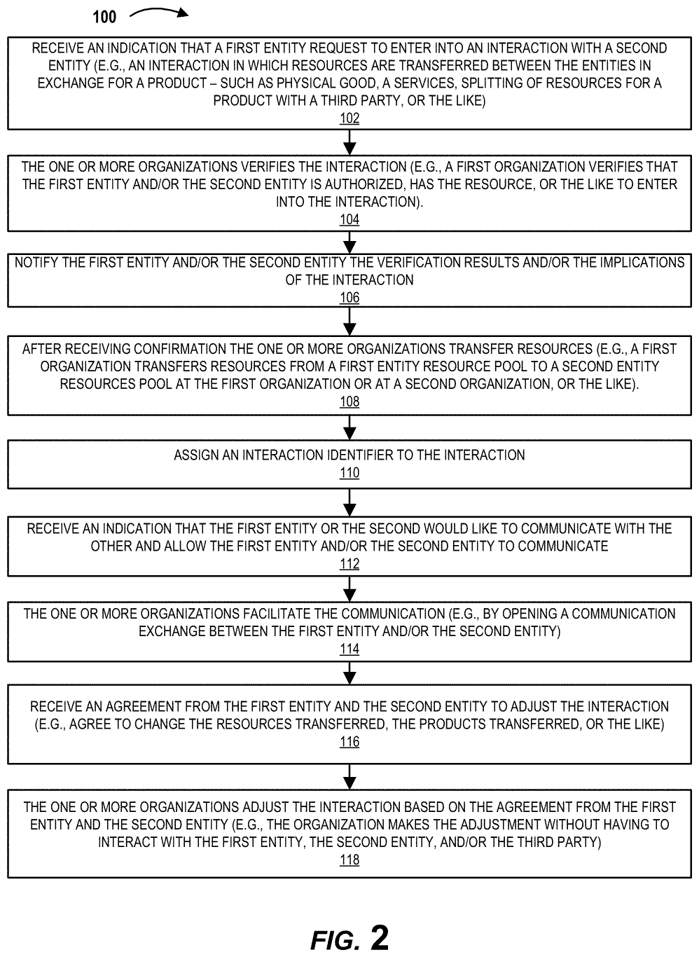

Despite the advantages of real time interactions, there are some disadvantages. It should be understood that while real-time interactions may include resource transfers that are final and irrevocable, the parties involved in the interaction may want to mutually revoke and/or adjust the interaction and/or the resources associated therewith. For example, the resource amount for an interaction may be incorrect (e.g., a user entered the wrong price), the resource transfer may be duplicate (e.g., sent twice), the product provided by an entity was not correct (e.g., wrong product sent, incorrect description), the interaction information may have changed (e.g., resource amount for a product changed, an after interaction discount is being applied, or the like), or the like. In typical interactions, should an entity want to revoke and/or adjust an interaction (e.g., the resources and/or products associated with an interaction), the entity may contact the organization, and the entity through the organization would request and adjustment. For example, an organization (e.g., financial institution) would be involved in the adjusting the interaction by being the intermediary between the interaction parties. For example, if potential misappropriation of the resources is involved, a first entity may request a refund by indicating to the organization that potential misappropriation has occurred, and the organization would reach out to the second entity regarding the potential misappropriation. Alternatively, an entity may cancel an interaction and/or request adjustment, and the organization would get involved in order to make sure the resources are properly adjusted (e.g., changed and/or refunded). Having the organization involved in adjusting interaction increases the processing speeds, processing capacity, system memory storage requirements, and/or costs for the organization. With respect to real-time interactions, this may be even more of an issue because these types of interactions were supposed to be final and irrevocable. As such, currently separate unrelated interactions between the entities may be required to adjust (e.g. revoke or change the interaction) the real-time resource transfer (e.g., separate resource transfers, or the like). As such, instead of the organization being involved in the after interaction adjustment determination (e.g., being the intermediary), the present invention provides a direct communication exchange between the entities involved in the interaction, in order to allow the entities to come to an agreement regarding the interaction before making additional interactions through the organization, requests of the organization, and/or inquiries with the organization. By creating a direct communication link between the entities involved in the interactions, the entities in the interactions are in the best position to adjust the interactions (as opposed to the organizations which only facilitated the interactions by transferring the resources). Moreover, the present invention also provides for improved verification (e.g., resource pool verification, entity verification, or the like) in order to allow the entities involved in the interaction to have improved identification of the other entity involved in the interaction. These concepts will be discussed in further detail herein with respect to FIG. 2.

FIG. 2 illustrates a resource transfer and communication exchange system, in accordance with one or more embodiments of the invention. As illustrated in block 102 of FIG. 2, the organization receives an interaction indication that a first entity enters into an interaction with a second entity. For example, as previously discussed herein the interaction may be a transaction that includes resources that are transferred between the entities in exchange for a product, such as a physical good, a service, splitting resources for a product with a third party, or the like. Moreover, as previously discussed herein the interaction information may include a request to transfer the resources utilizing the resource transfer systems for a real-time resource transfer over a real-time resource processing network. The interaction indication may further include interaction information, such as but not limited the resource pools involved in the interaction (e.g., a first entity resource pool, the second entity resource pool, or the like), the resource amount, the organization through which the resource transfer will take place, the first entity name, the second entity name, the first entity address, the second entity address, other entity interaction information (e.g., if there are additional entities involved in the interaction—a third entity splitting resources), or the like.

Block 104 of FIG. 2 further illustrates that the one or more organizations facilitating the interaction will verify the interaction. For example, the one or more organizations may be resource management organizations, such as financial institutions that manage the resource pools of the entities, intermediaries that facilitates the identification of the entities (e.g., third-party processors, or the like), organizations that manage the computer systems or applications thereof that are used in the interaction, or the like. The verification of the interactions may include verifying that the entities have the resources and/or products for the interaction, that the entities are the entities they claim to be, that the interaction does not result in an indication of potential fraud that may result in prevention (e.g., hold, deny, or the like the interaction), that resources are to be processed through a particular channel (e.g., a real-time resource transfer channel, or the like).

It should be understood that real-time resource transfer processing networks were initially set up to provide familiar entities (e.g., friends and families) to transfer resources directly outside of traditional processing networks. However, as these types of resource transfers have expanded to unfamiliar entities (e.g., between businesses and new customers, user to user through web site product exchanges, or the like) it has resulted in increased fraud, such as misappropriators taking over entity accounts, or simply posing as someone who they are not (e.g., to sell products they won't send). As such, in some embodiments of the invention, the verification process may include a determination by the organization of the safety of the interaction.

In some embodiments the determination of safety may include identifying how many times the entities have interacted in the past. When the entities have interacted in the past more than a threshold amount of times without issues then the interaction may be deemed safe. However, if the entities have not interacted before then the safety of the interaction may be in question.

In other examples, the determination may include identifying the resource amount being transferred in comparison to past resource amounts. When the resource amount is within the same ranges as past interactions and/or within a percentage the interaction may be deemed safe. However, if the resource amount is much greater than past interactions then the interaction may be deemed potentially unsafe even if the parties have interacted in the past.

In still other examples, the determination may include identifying the other interactions in which the entities have previously entered with third-parties. The organization may look at the entity names, addresses, resource pools involved in the present interaction, other resources pools of the entities not being used, or the like to determine the identity of the entities and the past interaction history of the entities. As such, even if the entities in the present interaction have not interacted before, if both entities have not been accused of fraud in the past or otherwise been involved in fraudulent interactions than the interaction may be deemed safe based on the identity of the entities. However, if the entities have had a history of fraud in the past (e.g., with the current resource pool, with other resource pools, or the like) the interaction may be deemed potentially unsafe.

The determination of the safety of the interaction may further include a determination of the trustworthiness identifier for the entities (e.g., score, percent safe, or the like). The trustworthiness of the entities may be determined by the organization, a third-party, or the like, and may be based on the credit score, past interactions, resource pool history (e.g., age of resource pool, number of interactions in the resource pool, time between interactions in the resource pool, or the like), identity of the entities, or the like).

In still other embodiments of the invention, entities may be pre-verified in order to enter into interactions through the real-time resource transfer processing network. For example, when an entity joins the network and/or specifically requests to be verified the organization may perform diligence with respect to the entity and impose requirements on entity to become verified. The requirements may include providing identification (e.g., picture ID, additional forms of identification, address information, resource pool statements, tax information, or the like), keeping a resource balance at a particular elevated level or a secondary resource pools from which resource may be accessed, provide collateral for being verified, or the like. When pre-verified, the entity may be allowed to enter into interactions on the real-time resource transfer network without being subjected to further scrutiny.

In some embodiments of the invention, the entities may set the preferences regarding when and how they are to be notified for real-time resource transfers. For example, a user may list other users and product providers that are safe, such that resource transfers will not be scrutinized for these safe entities. Moreover, the entities may set thresholds regarding the resource amounts that would result or fail to result in scrutinizing the resource transfers (e.g., transfers less than $20 would not be scrutinized, or the like). As such, when verifying an interaction the organization may review the entity preferences when determining if an interaction is considered safe by the entity entering into the interaction regardless of whether or not the organization determined that the interaction is safe. It should be understood that entity preferences may or may not override the organization's determination that the interaction is safe.

It should be further understood, that the process of verifying an entity may include providing a verification option (e.g., an entity validation option) to the entities to have the organization validate the second entity. For example, the organization or a third-party could perform a search of public records to determine if the second entity poses a safety threat for the interaction (e.g., if there is a chance the second entity may not provide the resources and/or the product associated with the interaction, or the like). The public records search may include using the phone number, the e-mail address, business or residence address, second entity name, or the like to identify public records that may provide insight into the second entity's ability to complete the interaction with the first entity. Should the first entity select the verification option, the organization and/or the third-party may validate the second entity (e.g., through the public records search). The validation of the second entity may be in exchange for a service payment provided by the first entity to the organization and/or third-party, or in some embodiments the validation of the second entity may be a service provided by the organization to its customers for interactions over a certain interaction resource amount (e.g., for large transfers of funds).

Block 106 of FIG. 2 illustrates that the organization notifies the first entity and/or the second entity regarding the verification and implications of the interaction. For example, the organization may provide the results of the verification to the first entity on the first entity computer systems. In some embodiments, the organization may indicate to the first entity that the interaction was verified or not verified (e.g., resources are available or not available), that the interaction is likely safe or may not be safe, and/or provide a reminder of the implications of the real-time resource transfer. For example, should the organization determine that the interaction may be potentially unsafe, as discussed with respect to block 104, then the organization may notify the first entity that the second entity may be unsafe. As such, the organization may notify the first entity of a safety indication of the second entity (e.g., score, or the like), the reasons that the second entity may be potentially unsafe (e.g., new resource pools is being used), second entity has been accused of fraud in the past (e.g., if allowed based on regulations), the location of the second entity and/or second entity resource pool (e.g., the first entity may think the interaction is occurring at a different location), and/or other interaction information. In some embodiments of the invention the notification from the organization may include a reminder of the interaction information, such as, a check on the resource amount being transferred (e.g., “your normal resource amount is $50, and the present amount is $2,000”). Additionally, the notification may include a reminder that the real-time resource transfer is permanent and irrevocable. In other embodiments, the notification may include an option for the first entity to route the interaction using a different channel should the organization determine that the interaction may be potentially unsafe (e.g., new resource pool for the second entity, or the like). In still other embodiments, the notification may be a requirement for additional authentication from the first entity and/or the second entity should the organization believe that the interaction is potentially unsafe due to the identification of the first entity or the second entity and/or the interaction information (e.g., resource amount is high).

FIG. 2 further illustrates in block 108 that the one or more organizations receive a confirmation of the interaction from the first entity and/or the second entity, and thereafter will transfer resources should the interaction be verified. For example, a first organization transfers resources from a first entity resource pool to a second entity resource pool at the first organization (e.g., when both entities have resource pools with the same organization) or at a second organization (e.g., when the entities have resource pools with different organizations). It should be understood that when the interaction is a real-time resource transfer using the resource transfer systems 30, the resources are transferred in real-time (e.g., instantaneously or near real-time), and as previously discussed herein may be irrevocable.

As illustrated by block 110 in FIG. 2 the one or more organizations and/or the one or more resource systems 30 may assign an interaction identifier to the interaction. For example, the interaction identifier may be numeric, alphabetic, alphanumeric, symbols, codes, and/or any other string of characters, or the like and may be used to identify the particular interaction. The interaction information for the interaction may be associated with the interaction identifier.

Block 112 of FIG. 2 illustrates that the organization (e.g., through the resource transfer systems 30, or the like) receives an indication that the first entity or the second entity would like to communicate (e.g., before or after the resources are transferred for the organization). In some embodiments, the first entity and/or the second entity may want to request and adjustment to the resources and/or product involved in the interaction, may want to create a receipt for an interaction, may want to create a trail regarding the products delivered and/or performed, may want to enter into follow up interactions, or the like. In some embodiments, the interactions that occur are undertaken through a real-time resource transfer network in which the parties may or may not know of each other. For example, the interaction may occur at an antique fair, yard sale, between user related to entertainment interactions (e.g., tickets to sporting or entertainment events, children's team or travel fees, interactions that occur over classified sites, or the like), between friends that include multiple entities (e.g., groups of people splitting resources for an interaction). In this way, the organization may directly, or indirectly through a third-party service provider, open a communicate exchange between the two or more entities involved in an interaction.

In some embodiments, the indication received may be a communication request to communicate with the second entity received through the use of a communication feature (e.g., link, selection button, icon, entry space, or the like on the first entity computer system interface). When the communication feature is selected, a communication may be sent to the second entity (e.g., with or without interaction information and/or a message from the first entity). In some embodiments, the communication request may include additional information, such as but not limited to the interaction identifier so that the parties may identify the interaction, or multiple interactions (should the requesting entity want to communicate regarding multiple interactions), the reason for the request (e.g., discuss an adjustment to the resource, request a return, damaged product, discussed suggested adjustment, or the like), interaction information (e.g., product, resources transferred, party names, interaction date), or the like. In some embodiments, reason for the request may be based on reason codes that the first entity may be select and/or a message in which the first entity may include a personalized communication regarding the reason for the communication. Moreover, it should be understood that the communication may take the form of an e-mail, instant message, voicemail, SMS message, and/or any other type of communication.

It should be understood that the communication request may be received from either the first entity or the second entity (or another entity if there are more than two parties which may be sent all the parties or a single party). The communication request, in some embodiments may include a request for a resource adjustment (e.g., resource amount change, resource refund, or the like). For example, the first entity may request an adjustment should the product not arrive or is late, the product is not what the first entity expected, the product is damaged, the incorrect amount was sent to the second entity (e.g., entity entered the wrong price, the amount for the product was not labeled correctly, the entity sent the resources twice, or the like), the resource amount has changed (e.g., the entities were splitting cost associated with a third-party product that has changed), the interaction was entered into by dependent of the first entity that did not have authorization (e.g., child or roommate order a car service, made in-game purchases within a video game, or the like), or the like. Alternatively, the second entity may request an adjustment if the resource amount has changed (e.g., the entities were splitting cost associated with a third-party prodder that has changed), the user is not using the product as required, resource amount was incorrect, the first entity owes additional resource transfer installments, or the like. In some embodiments the communication may not be for requesting an adjustment, and instead may simply relate to a confirmation that the product is being sent (e.g., confirmation concert tickets were sent, or the like), requesting additional information about the product, or the like.

FIG. 2 further illustrates in block 114 that the organization may facilitate the communication between the entities by opening up the communication link. The organization or a third-party may allow the entities to communicate through the resource transfer system 30 by allowing the entities to communicate over the resource transfer systems 30. The entities may communicate with each other under until an agreement is reached between the entities, such as no adjustment to the resources are necessary, an adjustment is necessary, the organization needs to be involved, or the like. The communications may be documented and/or described based on the agreement in order to provide documentation of such agreement regarding the interaction. In some embodiments, some of the communications may be documented (e.g., final agreement) while others might be discarded (e.g., initial discussions). In some embodiments both parties must agree before the communications become stored to formalize the agreement for the adjustment.

Block 116 illustrates that organization receives an agreement from the first entity and the second entity related to the interaction, and in particular, how to adjust resources associated with the interaction. It should be understood that the agreement between the first entity and the second entity may include an agreed upon resource amount (e.g., amount of the original interaction, change to the original resource amount, or the like), the date at which the adjustment should occur, requirement to hold the funds in escrow until the occurrence of an event (e.g., product is returned, or the like), or the like. In this way, the organization is notified regarding a resource adjustment only after an agreement has been made. As such, the present invention prevents the organization from having to be involved in the interaction before the entities come to an agreement regarding the interaction. Consequently, the organization does not require the additional processing capacity, processing speeds, processing memory or the like required for the organization to be the intermediary between resolving any conflicts between the first entity and the second entity regarding the interaction. Moreover, the present invention allows the first entity and second entity to communicate directly having all of the information associated with the interaction from the organization that facilitated the interaction attached to the communication, instead of having to have the organization take control or instead of having to reach out to the entity outside of the organization that facilitated the interaction (e.g., which may require the first entity to find the second entity, the contact information for the second entity, then try to identify the details of the interaction and reach out to the second entity with potential issues).

FIG. 2 illustrates in block 118 that the one or more organizations adjust the interaction (or multiple interactions) according to the agreement from the first entity and the second entity and/or other entities should multiple entities be involved in the interaction. In some embodiments, the organization may adjust the interaction even after the resource transfer has already occurred. Moreover, it is likely that the resource transfer has already occurred in the case of real-time resource transfer interactions, and as such, a supplementary interaction may automatically be initiated by the organization based on the agreement. For example, the one or more organizations may transfer resource from a first resource pool or from a second resource pool. Moreover, the supplementary interaction may be given an interaction identifier that is the same as the interaction identifier as the initial interaction. Alternatively, the interaction identifier may be based on the initial interaction identifier (e.g., include a root of the initial interaction identifier and have an extension of the interaction identifier), be assigned a supplementary interaction identifier that may be linked with the initial interaction identifier, or the like. As such, the supplemental interaction will be associated with the original interaction. Should the entities want to make additional adjustments, the entities may enter now communications and reference the interaction identifier and/or the supplemental identifier.

In some embodiments of the invention the communication link between the first entity and the second entity may be facilitated by a chat bot that may automatically create the communication link between the entities, provide the interaction information based on the interaction identifier, provide the form of the agreement that the entities may agree to, provide the authorization for finalizing the agreement for the supplemental resource transfer, secure the resource for the supplemental resource transfer, finalize the resource transfer, provide a digital receipt, or the like without the organization having to investigate any requested adjustment from the first entity and the second entity.

In some embodiments of the invention it should be understood that the communication request may be made before entering the interaction with the second entity in order to get additional information about the second entity (e.g., trustworthiness indicator, or the like). As such, before entering an interaction with the second entity the first entity may communicate with the second entity and/or the organization. For example, in some embodiments the first entity may request verification of the second entity before entering into the interaction with the second entity (e.g., requesting the second entity name, location of the second entity resource pool, address of the second entity, determine if the second entity has been pre-verified, or the like).

It should be understood that the systems described herein may be configured to establish a communication link (e.g., electronic link, or the like) with each other in order to accomplish the steps of the processes described herein. The link may be an internal link within the same entity (e.g., within the same organization) or a link with the other systems. In some embodiments, the one or more systems may be configured for selectively responding to dynamic inquires. These feeds may be provided via wireless network path portions through the Internet. When the systems are not providing data, transforming data, transmitting the data, and/or creating the reports, the systems need not be transmitting data over the Internet, although it could be. The systems and associated data for each of the systems may be made continuously available, however, continuously available does not necessarily mean that the systems actually continuously generate data, but that a systems are continuously available to perform actions associated with the systems in real-time (i.e., within a few seconds, or the like) of receiving a request for it. In any case, the systems are continuously available to perform actions with respect to the data, in some cases in digitized data in Internet Protocol (IP) packet format. In response to continuously receiving real-time data feeds from the various systems, the systems may be configured to update actions associated with the systems, as described herein.

Moreover, it should be understood that the process flows described herein include transforming the data from the different systems (e.g., internally or externally) from the data format of the various systems to a data format associated with a particular display. There are many ways in which data is converted within the computer environment. This may be seamless, as in the case of upgrading to a newer version of a computer program. Alternatively, the conversion may require processing by the use of a special conversion program, or it may involve a complex process of going through intermediary stages, or involving complex “exporting” and “importing” procedures, which may convert to and from a tab-delimited or comma-separated text file. In some cases, a program may recognize several data file formats at the data input stage and then is also capable of storing the output data in a number of different formats. Such a program may be used to convert a file format. If the source format or target format is not recognized, then at times a third program may be available which permits the conversion to an intermediate format, which can then be reformatted.

As will be appreciated by one of skill in the art in view of this disclosure, embodiments of the invention may be embodied as an apparatus (e.g., a system, computer program product, and/or other device), a method, or a combination of the foregoing. Accordingly, embodiments of the invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the invention may take the form of a computer program product comprising a computer-usable storage medium having computer-usable program code/computer-readable instructions embodied in the medium (e.g., a non-transitory medium, or the like).

Any suitable computer-usable or computer-readable medium may be utilized. The computer usable or computer readable medium may be, for example but not limited to, an electronic, magnetic, optical, electromagnetic, infrared, or semiconductor system, apparatus, or device. More specific examples (a non-exhaustive list) of the computer-readable medium would include the following: an electrical connection having one or more wires; a tangible medium such as a portable computer diskette, a hard disk, a random access memory (RAM), a read-only memory (ROM), an erasable programmable read-only memory (EPROM or Flash memory), a compact disc read-only memory (CD-ROM), or other tangible optical or magnetic storage device.

Computer program code/computer-readable instructions for carrying out operations of embodiments of the invention may be written in an object oriented, scripted or unscripted programming language such as Java, Pearl, Python, Smalltalk, C++ or the like. However, the computer program code/computer-readable instructions for carrying out operations of the invention may also be written in conventional procedural programming languages, such as the “C” programming language or similar programming languages.

Embodiments of the invention described above, with reference to flowchart illustrations and/or block diagrams of methods or apparatuses (the term “apparatus” including systems and computer program products), will be understood to include that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute via the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment of the invention.

Specific embodiments of the invention are described herein. Many modifications and other embodiments of the invention set forth herein will come to mind to one skilled in the art to which the invention pertains, having the benefit of the teachings presented in the foregoing descriptions and the associated drawings. Therefore, it is to be understood that the invention is not to be limited to the specific embodiments disclosed and that modifications and other embodiments and combinations of embodiments are intended to be included within the scope of the appended claims. Although specific terms are employed herein, they are used in a generic and descriptive sense only and not for purposes of limitation.

### INCORPORATION BY REFERENCE

To supplement the present disclosure, this application further incorporates entirely by reference the following commonly assigned patent applications:

| | U.S. patent | | |
|---|---|---|---|
| Docket Number | application Ser. No. | Title | Filed On |
| 8805US1.014033.3377 | To be assigned | REAL-TIME RESOURCE PROCESSING | Concurrently |
| | | BASED ON RESOURCE CHANNEL | herewith |
| | | FACTORS | |

What is claimed is:

1. A resource transfer and communication exchange system, the system comprising:
one or more memory components having computer readable code stored thereon; and
one or more processing components operatively coupled to the one or more memory components, wherein the one or more processing components are configured to execute the computer readable code to:
receive a request from a first entity to enter into an interaction with a second entity, wherein the interaction includes a transfer of resources from the first entity to the second entity;
verify the first entity or the second entity for the interaction;
secure the resources from the first entity for the interaction;
receive a communication request from the first entity or the second entity for communication between the first entity and the second entity regarding the interaction;
allow the communication between the first entity and the second entity:
receive an agreement from the first entity or the second entity for an interaction adjustment; and
adjust the interaction based on the agreement from the first entity and the second entity.

2. The system of claim 1, wherein the one or more processing components are configured to execute the computer readable code to assign an interaction identifier to the interaction.

3. The system of claim 2, wherein the one or more processing components are configured to execute the computer readable code to:
identify interaction information for the interaction between the first entity and the second entity; and
include the interaction information in the communication between the first entity and the second entity.

4. The system of claim 3, wherein the interaction information is identified by the interaction identifier assigned to the interaction between the first entity and the second entity.

5. The system of claim 3, wherein the interaction information comprises a status of the interaction, the resources being transferred, a product associated with the interaction, a resource transfer schedule, a first entity resource pool, and a second entity resource pool.

6. The system of claim 1, wherein the communication comprises real-time messages between the first entity and the second entity through one or more resource transfer systems without input from an organization facilitating the interaction.

7. The system of claim 1, wherein adjusting the interaction based on the agreement occurs by accessing the interaction based on an interaction identifier.

8. The system of claim 1, wherein the agreement between the first entity and the second entity occurs through the communication between the first entity and the second entity without involvement from an organization.

9. The system of claim 1, wherein the agreement is a return of the resources to the first entity.

10. The system of claim 1, wherein the agreement is an adjustment of the resources for the interaction and a return of a portion of the resources to the first entity or an increase in the resources provided to the second entity.

11. The system of claim 1, wherein the resource transfer from the first entity to the second entity is in response to the interaction for a product from the second entity.

12. The system of claim 1, wherein the resource transfer from the first entity to the second entity is in response to sharing resources for a product from a third-party.

13. The system of claim 1, wherein verifying the interaction comprises:
identifying when the second entity is using a new resource pool for the interaction, when a resource amount is greater than a threshold amount, or when a second entity resource pool has not been used within a time period;
notify the first entity of a potential safety indication.

14. The system of claim 1, wherein before securing the resources from the first entity for the interaction the one or more processing components are configured to execute the computer readable code to:
determine a safety indication for the interaction; and
notify the first entity of the safety indication before allowing the first entity to enter into the interaction.

15. The system of claim 1, wherein before securing the resources from the first entity for the interaction the one or more processing components are configured to execute the computer readable code to:
determine a potential safety indication for the interaction;
access first entity safety preferences;
notify the first entity of the safety indication when the safety preferences are met; and
allow the interaction when the safety preferences are not met.

16. The system of claim 1, wherein verifying the interaction comprises:
identifying when the second entity is a pre-verified entity; and
notify the first entity when the second entity is not the pre-verified entity; and
allowing the interaction when the second entity is the pre-verified entity.

17. The system of claim 1, wherein verifying the interaction comprises:
identifying a trustworthiness identifier for the second entity; and
notify the first entity of the trustworthiness identifier for the second entity before allowing the interaction.

18. A computer implemented method for a resource transfer and communication exchange system, the method comprising:
receiving, by one or more processing devices, a request from a first entity to enter into an interaction with a second entity, wherein the interaction includes a transfer of resources from the first entity to the second entity;
verifying, by the one or more processing devices, the first entity or the second entity for the interaction;
securing, by the one or more processing devices, the resources from the first entity for the interaction;
receiving, by the one or more processing devices, a communication request from the first entity or the second entity for communication between the first entity and the second entity regarding the interaction;
allowing, by the one or more processing devices, the communication between the first entity and the second entity:
receiving, by the one or more processing devices, an agreement from the first entity or the second entity for an interaction adjustment; and
adjusting, by the one or more processing devices, the interaction based on the agreement from the first entity and the second entity.

19. The method of claim 18, further comprising:
assigning, by the one or more processing devices, an interaction identifier to the interaction;
identifying, by the one or more processing devices, interaction information for the interaction between the first entity and the second entity; and
including, by the one or more processing devices, the interaction information in the communication between the first entity and the second entity.

20. A computer program product for a resource transfer and communication exchange system, the computer program product comprising at least one non-transitory computer-readable medium having computer-readable program code portions embodied therein, the computer-readable program code portions comprising:
an executable portion configured to receive a request from a first entity to enter into an interaction with a second entity, wherein the interaction includes a transfer of resources from the first entity to the second entity;
an executable portion configured to verify the first entity or the second entity for the interaction;
an executable portion configured to secure the resources from the first entity for the interaction;
an executable portion configured to receive a communication request from the first entity or the second entity for communication between the first entity and the second entity regarding the interaction;
an executable portion configured to allow the communication between the first entity and the second entity:
an executable portion configured to receive an agreement from the first entity or the second entity for an interaction adjustment; and
an executable portion configured to adjust the interaction based on the agreement from the first entity and the second entity.
